(19) United States
(12) Patent Application Publication
(10) Pub. No.: US 2019/0019003 A1
(43) Pub. Date: Jan. 17, 2019

(54) PORTABLE NON-CONTACT MULTISPECTRAL FINGERPRINT AND / OR PALM PRINT IMAGING DEVICE

(71) Applicant: GRÌMED SAGLIK HÌZMETLERÌ VE BÌLGÌSAYAR ÜRÜNLERÌ SANAYÌ TÍCARET LÍMÌTED SÍRKETÌ, Istanbul (TR)

(72) Inventor: Osman Eski, Sisli/Istanbul (TR)

(21) Appl. No.: 16/078,553

(22) PCT Filed: Feb. 17, 2017
(86) PCT No.: PCT/TR2017/050065

§ 371 Date: Aug. 21, 2018

(30) Foreign Application Priority Data
Feb. 21, 2016 (TR) 2016/02191

(51) Int. Cl. G06K 9/00; G06K 9/20; H04N 5/225

(52) U.S. Cl. CPC G06K 9/00033; H04N 5/2254; H04N 5/2256; G06K 9/2018

(57) ABSTRACT

The invention particularly relates to a multispectral imaging apparatus which is used in forensic medicine, forensic science and criminal fields for the detection, data and image retrieval, recording, scaling and sharing of fingerprints and/or palm prints left at the crime scene; which can be integrated into cameras, video cameras, mobile phones and portable mobile imaging systems allowing non-contact multispectral imaging at different wavelengths.

### TECHNICAL FIELD

The invention particularly relates to a multispectral imaging apparatus which is used in forensic medicine, forensic science and criminal fields for the detection, data and image retrieval, recording, scaling and sharing of fingerprints and/or palm prints left at the crime scene; which can be integrated into cameras, video cameras, mobile phones and portable mobile imaging systems allowing non-contact multispectral imaging at different wavelengths.

More particularly, the invention relates to a method where a portable apparatus, which can be integrated to current imaging systems, is used for obtaining images of fingerprints and/or palm prints left at the crime scene quickly and clearly without the use of dust, gas or similar chemicals by transmitting light at certain wavelengths and at certain angles and after that being filtered by means of color filtering with the chosen color filters to display in a distinguishable way.

### BACKGROUND OF THE INVENTION

The present technique includes different stationary fingerprint and/or palm print imaging systems which are used in the criminal laboratories.

These systems are not mobilized because they are connected to mains or have big size preventing portability.

Most of the systems that are mobile and connected to the camera and/or video camera receive images only with a filter and/or light system positioned in front of the lens.

Due to the position of the light and the angle of incidence, it is not possible to clearly record the entire area that needs to be displayed, and therefore different additional applications such as different chemical powders or gas are required in order for the fingerprint to be clearly seen.

Mobile systems that transmit light from different angles in white light have been implemented, either not achieving the desired image clarity or insufficient on different application floors.

Moreover, nearly all of the portable systems developed for fingerprint imaging in criminal field work in a single band range, i.e. they work only in the ultraviolet (UV), only at visible wavelength (VIS), or only in near infrared (NIR) bands.

One of the main reasons for this is that the light system is not multispectral in systems that try to send light at different angles to avoid reflection.

Some mobile systems available in the prior art use external light sources (torches, etc.), a small number of manually removable filters, and multiple camera systems to illuminate different wave lengths.

This leads to difficulties in use, the need for separate equipment for assembling and disassembling, and loss of time and money.

Difficulties in eliminating manufacturing difficulties, solving the problems during use, high cost and other inadequacies of existing solutions have necessitated a development in the related technical field.

### SUMMARY OF THE INVENTION

The object of the invention which removes the known disadvantages of the technique is to enable the users who are operating in the criminal field to obtain clear fingerprint and/or palm print images at the crime scene instantly without additional applications which are life-threatening like application of harmful chemical substances or gases.

Another object of the invention is to be able to transfer the obtained data in a scalable manner and to detect the fingerprint and/or palm print owner as soon as possible after taking the fingerprint and/or palm print images clearly at the crime scene.

Another object of the invention is to ensure that the evidences found at the crime scene are displayed without contact and damage.

Another object of the invention is to provide a non-contact and non-destructive imaging, allowing DNA detection or any other process after that to be carried out in a reliable and correct manner.

Another objective of the invention is to provide easy and instant imaging thanks to its integrated structure with interchangeable lighting system and a portable, interchangeable internal power supply unit.

Another object of the invention is to improve the application areas and to obtain clear images from a number of different surfaces with its multifunctional hardware.

In order to provide the above advantages, the invention provides a system and method for displaying the fingerprint and/or palm print of the hand clearly and without excess reflection without the need of additional equipment which includes, a beam splitter system which can reflect in one and/or multiple different bandwidths with an integrated interchangeable one and/or multiple wavelength illumination system integrated into the camera integrated mobile devices, a filter system which can be mounted to the unit and can be rotated or slid, optional interchangeable portable battery system providing additional energy requirements and which can be inserted and removed on the unit and which can be switched on and off, a body which allows the mobile device to be fixed and which aligns the angle of view with the center of the illuminated area.

### BRIEF DESCRIPTION OF THE DRAWINGS

FIG. 1; A representative perspective view of the said imaging apparatus.

FIG. 2; A representative perspective view of the said imaging apparatus from a different angle.

FIG. 3; A representative view of the assembly of the said imaging apparatus.

### REFERENCE NUMBERS

10. Imaging device
20. Imaging device junction
30. Main body
40. Tripod
41. Tripod junction
50. Battery
51. Battery junction
60. Beam splitter
61. Light background
62. Rear cover
70. Movable lens hood
80. Lighting system
90. Scaled Image background
100. Disc top cover
110. Filter disc 120. Lens disc
130. Disc bottom cover

### DETAILED DESCRIPTION OF THE PREFERRED EMBODIMENT

In the present technique, fingerprints and/or palm prints are displayed in the crime scene or laboratories after the transfer of materials that can be transported from the crime scene.

At the crime scene, many evidences that can be imaged are not transferable to the laboratory. The effort for the transfer of evidence without any damage leads to serious time losses. It is also difficult and costly. Dust, gas and similar chemical substances are used to obtain a trace image from these evidences. Contact with these substances is extremely harmful and risky for the health of the user.

In addition, since these chemical processes may cause damage to the trace, after that it is not possible to carry out different analyzes like DNA analysis used in determining the trace holder. For this reason, easy-to-move systems that can take images at the crime scene and on the spot are extremely important.

The inventive imaging device (10) provides non-contact imaging, whereby the evidence is not damaged.

The tripod (40) provides a junction to the imaging device (10) with mobile devices such as a camera, a video camera, a mobile phone containing a camera, a tablet or a similar mobile device. Said tripod (40) is in contact with the imaging device (10) from the tripod junction (41).

It is designed to have a 90° angle with the lighting center reflected in the examined area and the camera. Thus, sparkles are removed from the taken image.

In the system of the present invention, the light transmitted through the lighting system (80) connected to the main body (30) on the imaging device (10) must be sent parallel to the beam splitter (60) according to the area to be imaged. Said light beam-splitter (60) is positioned at a 45° angle to the transmitted light sent to the field to be imaged.

The camera and similar recording devices must be located at the imaging device junction (20) with a vertical angle of 90° to the illumination center of the area to be imaged.

The invention relates to a method and system provides clear imaging of the fingerprint and/or the palm print of a hand in a distinguishable manner on different surfaces such as dark, light, patterned, metallic or similar surfaces by filtering light with the help of filters positioned on the disks 110 (these can be band-pass, long pass, short pass or color filters), sent at a selected wavelength selected from the light system (80).

The inventive imaging device (10) has the feature that the filter disc (110) can be rotated or slid if manufactured in a sliding form without the need for additional tools in situations where it is necessary to use the filter system.

For this feature, a filter disc (110) which allows one and/or more filters to be positioned, and a lens disc (120), which may optionally be connected to one and/or more additional lenses are positioned between the disc top cover (100) and the disc bottom cover (130), which is located on the main body and which is connected to the imaging device junction (20) where the portable device cameras are aligned with.

The disc top cover and bottom cover can be inserted and removed as a whole, the filter disc and lens disc located between them are selectable and can be changed.

The filter system, center of the disk top cover (100) and the disk bottom cover (130), are shown to be positioned such that the beam center transmitted at certain selected wavelength with the light system (80), will form a 90° angle.

This filter system disc top cover (100) is capable of connecting a camera, a video camera, a smartphone with camera features, a tablet or similar mobile devices to the main body. The tripod (40), which is capable of moving up and down or the left-right direction, is connected to the main body (30) by the tripod junction (41) and establishes the connection of the mobile devices to the imaging system (10).

The devices to be used at the crime scene must have a power supply unit for lighting. The fact that this unit has its own power supply to use, it allows long time and more comfortable usage for observing the area. The inventive imaging device (10) has a replaceable battery (50) for the light system (80) and other energy-requiring system components. The battery (50) can be fixed on the main body (30) via the battery junction (51) or can be attached and detached for external transportation.

In order to be able to make clear imaging in the crime scene, the field to be examined must be illuminated at a sufficient level. The light system (80), which has a high illumination power and can illuminate at selected one and/or multiple specific wavelengths, is connected to the integrated body, and the additional body can be changed without the need of an additional tool.

The internal replaceable battery (50) is mobile and easy to carry thanks to its lightweight structure.

The ray must be sent at a 90° angle to the camera for a clear imaging of the fingerprint and/or palm print trail.

Thus, the inventive imaging apparatus (10) is provided with a semi-transparent and semi-reflective beam splitter (60) at the center of the main body (30). Said light reflective beam splitter (60) is positioned at a 45° angle to the selected wavelength beam which comes from the lighting system (80) and passes through the scaled imaging background (90).

The beam splitter (60) is capable of transmitting 50% and reflecting the remaining 50% of the rays in selected ultraviolet (UV), visible spectrum (VIS) and near infrared (NIR) range.

The Light background (61) and the rear cover (62) located behind the beam splitter (60) are coated with materials that are smoothly painted in black or covered with black colored cloths etc. for a stronger illumination.

The scaled image background must be fixed and must be interchangeable without the need of an additional tool (in white and other colors, to create background in the image or to translate a single light beam to different wave lengths).

The beam splitter (60) is fixed and/or replaceable without any additional tools. If applied in a fixed form, it should have a transparent and reflective property in the range of 330-1100 nm. In areas where only UV work should be carried out, the beam splitter should have a translucent and reflective characteristic in the UV range of 200-400 nm.

If operation is done only in VIS white light range, the beam splitter (60) must have at least a transparent and reflective property in the range of 400-700 nm.

Some applications require a distance up to one meter between the camera and evidence in order to capture a clear image.

While illuminating the evidence from this distance, different lights that may come from the outside can adversely affect the image clarity. In this case, a sliding lens hood (70), which has an adjustable length, is used with the aim of preventing the area between the evidence and the imaging device (10) from being affected by the external environment. In this way, the fingerprint and/or the palm print trace is isolated from the outside environment by the extending or shortening the cover according to the distance, thus, imaging can be done with high clarity. It is not necessary to take the evidence from the crime scene to the dark room or to create a dark environment for the examination and photographing, and it is possible to work more comfortably.

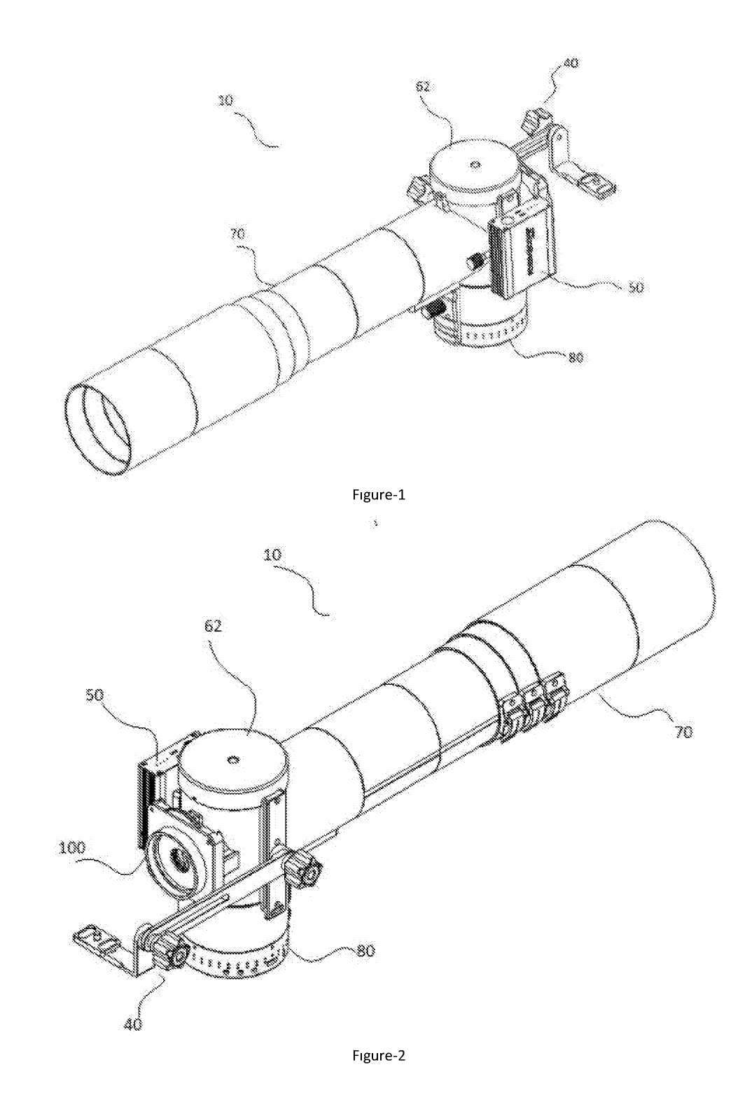

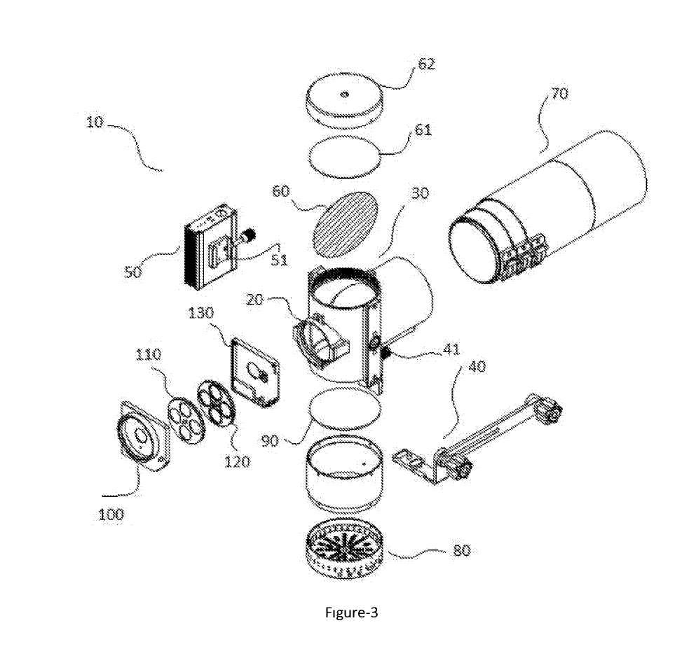

The imaging device (10) of the present invention, which is shown in FIGS. 1 and 2, has been disclosed in such a way as to meet all these needs.

1. A multispectral imaging device (10) which is used in forensic medicine, forensic science and criminal fields for the detection, data and image retrieval, recording, scaling and sharing of fingerprints and/or palm prints left at a crime scene; which can be integrated into cameras, video cameras, mobile devices and portable mobile imaging systems allowing non-contact multispectral imaging at different wavelengths, including:
a lighting system (80) for emitting light in one and/or multiple wavelength ranges,
a scaled image background (90) for scattering the light equally,
a beam splitter (60) which is semi-transparent and semi-reflective,
a light background (61) for clear imaging,
a rear cover (62),
a main body (30) which enables fixation of the mobile device, and aligning of a field of view with a center of an illuminated area to be imaged.

2. The imaging device (10) according to claim 1, characterized in that:
the light transmitted must be sent parallel to the area to be imaged to said beam splitter (60) from said lighting system (80) which is connected to said main body (30) on said imaging device (10).

3. The imaging device according to claim 1, characterized in that:
said beam splitter (60) is positioned at a 45° angle to a selected wavelength beam which comes from the lighting system (80) parallel to the area to be image.

4. The imaging device (10) according to claim 1, characterized in that:
cameras, video cameras, mobile phone cameras and portable mobile imaging system cameras which enable data and image retrieval, recording, scaling and sharing, are located at an imaging device junction (20) with a vertical angle of 90° to a center of the beam splitter (60) positioned within the main body (30).

5. The imaging device (10) according to claim 1, comprising:
a sliding lens hood.

6. The imaging device (10) according to claim 1, comprising:
a pluggable battery (50) that meets requirements of energy-demanding systems located thereon.

7. The imaging device according to claim 1, wherein the light background (61) is coated with a black or close to black color cloth or painted in black or close to black color.

8. The imaging device according to claim 1, wherein the rear cover (62) is coated with a black or close to black color cloth or painted in black or close to black color.

9. The imaging device according to claim 1, characterized in that:
the beam splitter (60) is transparent and reflective at a 330-1100 nm wavelength range.

10. The imaging device according to claim 1, characterized in that:
the beam splitter (60) is transparent and reflective at a 200-400 nm wavelength range where Ultraviolet (UV) is necessary.

11. The imaging device according to claim 1, characterized in that:
the beam splitter (60) is transparent and reflective at a 400-700 nm wavelength range where visible spectrum (VIS) is necessary.
